(19) United States
(12) Patent Application Publication
(10) Pub. No.: US 2002/0188695 A1
(43) Pub. Date: Dec. 12, 2002

(54) Auto file opening system and method

(76) Inventor: Frank Tso, Taipei (TW)

Correspondence Address: BIRCH STEWART KOLASCH & BIRCH, PO BOX 747, FALLS CHURCH, VA, 22040-0747, US

(21) Appl. No.: 09/940,511

(22) Filed: Aug. 29, 2001

(30) Foreign Application Priority Data
Jun. 7, 2001 (TW) 90113806

(51) Int. Cl. G06F 15/16

(52) U.S. Cl. 709/218; 709/217

(57) ABSTRACT

The invention provides an auto file opening system, which is implemented in an electronic apparatus including a storage device for storing a first table and a network connection device. The network connection device connects to a web server, which stores a second table. The auto file opening system according to the invention includes a table search module and a file opening module. The table search module searches the corresponding relationships between the application and the extension from the data stored in the first table and the second table automatically when a user wants to open a file. The file opening module runs the application according to the corresponding relationship between the application and the extension to open the file.

### BACKGROUND OF THE INVENTION

1. Field of Invention

The invention relates to an auto file opening system and the method and, in particular, to an auto file opening system that can automatically open files with specific extension names and the corresponding method.

2. Related Art

In the prior art, wher a user wants to open one file by clicking the file, the OS (Operating System) in an electronic apparatus, such as a computer or a PDA (Personal Digital Assistant), will automatically obtain the information about a application program for opening the file according to the extension/application table stored in the electronic apparatus. The appropriate application is then executed to open the file.

The extension/application table stores the corresponding information between applications and extensions. That is, it stores the data to find the appropriate application program for opening files with a certain extension. Taking the Windows OS as an example, a user can select the “Folder Options” under the menu “View” in “Windows Explorer” to set the corresponding relationships among extensions and application programs. These relations will be stored in the registry of the Windows OS. When the user clicks one file, the Windows OS will follow the data stored in the registry to automatically select the right application program to open the file. In other words, the extension/application table is stored in the registry of the Windows OS.

If the extension/application table does not record the corresponding information between an application and an extension, the OS will ask the user to select an application to open the file. However, it is often the case that the user does not know which application to be used to open the file. This causes a great deal of trouble for the user, who usually stops the process of opening the file.

On the other hand, when the electronic apparatus is not installed with an appropriate application, the user has to find and install it oneself. This procedure often confuses the user and wastes his time.

From the above description, one can see that when there is no extension/application correspondence in the extension/application table for opening a particular file, the user has to search for the application or even install a new application. This results in great inconvenience. Therefore, how to provide a system and a method that make opening a file easy is currently an important subject.

### SUMMARY OF THE INVENTION

Pursuant to the above problems, it is an objective of the invention to provide an auto file opening system and the corresponding method. When the extension/application table of an electronic apparatus does not have the corresponding relationship between an extension and an application, the invention will automatically search for the relationship elsewhere (e.g., in a web server).

It is also another objective of the invention to provide an auto file opening system and the corresponding method, which will automatically download and install the application needed for opening the file when the electronic apparatus is not installed with the appropriate application.

To achieve the above objective, the system according to the invention is implemented in an electronic apparatus, which includes a table search module and a file opening module. Furthermore, the electronic apparatus includes a storage device that stores a first table and a network connection device. The electronic apparatus uses the network connection device to connect with a web server through the Internet. The web server stores a second table. The first table and the second table record the corresponding relationship between an application and at least one extension. In the current invention, the table search module automatically searches for the corresponding relationship between an application and an extension stored in the first table and the second table. The file opening module automatically executes the appropriate application according to the corresponding relationship between an extension and an application, and the application opens a file with the extension.

The invention also provides an auto file opening method implemented in an electronic apparatus that includes a table searching procedure and a file opening procedure. The table searching procedure automatically searches for the corresponding relationship between an application and an extension stored in a first table and a second table. The file opening procedure automatically executes the appropriate application according to the corresponding relationship between an application and an extension, and the application opens a file with the extension.

The system and method according to the invention can automatically search the extension/application table storing the corresponding relationships among the applications and the extensions and find the necessary application for opening the file. It can further automatically install the application if it is not already existent in the system. Thus, the user can open any file without difficulty.

### BRIEF DESCRIPTION OF THE DRAWINGS

The invention will become more fully understood from the detailed description given in the herein below illustration only, and thus are not limitative of the invention, and wherein:

FIG. 1 is a block diagram showing the structure of an auto file opening system according to a preferred embodiment of the invention;

FIG. 2 is a schematic view showing how the auto file opening system according to the preferred embodiment of the invention, web server and a computer apparatus communicate with one another; and

FIG. 3 is a flowchart showing the procedure of the auto file opening method according to the preferred embodiment of the invention.

### DETAILED DESCRIPTION OF THE INVENTION

The invention will be apparent from the following detailed description, which proceeds with reference to the accompanying drawings, wherein the same references relate to the same elements.

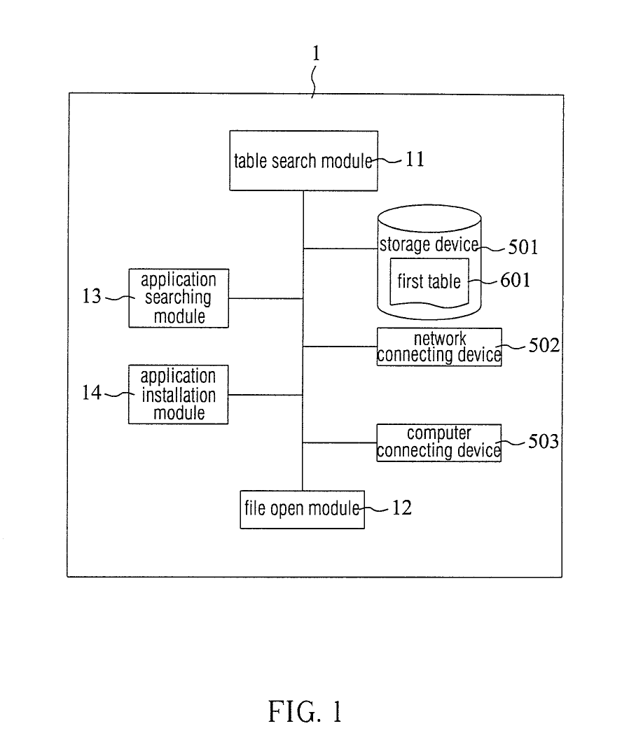

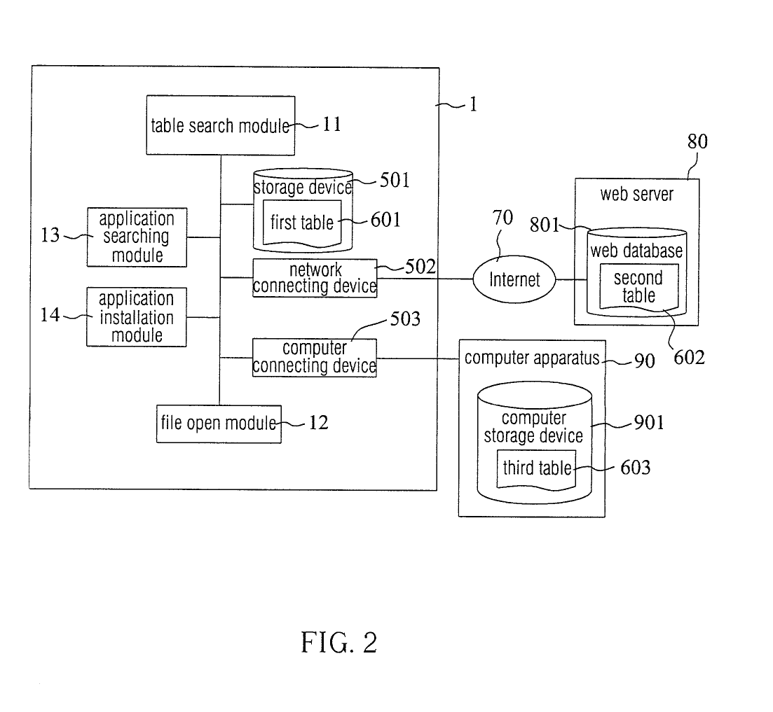

With reference to FIGS. 1 and 2, a preferred embodiment of the auto file opening system 1 of the invention is implemented in an electronic apparatus 50. It has a table search module 11 and a file opening module 12.

The electronic apparatus 50 contains a storage device 501, a network connection device 502 and a computer connection device 503. The storage device 501 stores a first table 601. In the current embodiment, the storage device 501 can be a DRAM (Dynamic Random Access Memory), a flash RAM or a hard disk drive.

The electronic apparatus 50 uses the network connection device 502 to build up the connection with a web server 80 through the Internet 70. A second table 602 is stored in a web database 801 in the web server 80. For example, the network connection device 502 is a modem. Therefore, the table search module 11 directly dials up the network and searches the records stored in the second table 602 of the web server 80.

It should be noted that aside from the previously mentioned wired connection with the web server 80, the network connection device 502 could further build up a wireless connection with the web server 80. For example, it can use the IEEE 802.11 protocol to wirelessly connect to an access point and then to the Internet. Alternatively, it can connect to the network directly through a mobile phone. Any skilled person can make appropriate modifications to the invention.

The electronic apparatus 50 uses the computer connection device 503 to connect to a computer apparatus 90. A third table 603 is stored in a computer storage device 901 of the computer apparatus 90. For example, the computer connection device 503 is a USB (Universal Serial Bus). The electronic apparatus 50 uses the computer connection device 503 to connect to the computer apparatus 90 through a transmission wire. Therefore, the table search module 11 connects to the computer apparatus 90 via the USB and searches the records stored in the third table 603 in the computer storage device 901 of the computer apparatus 90. As another example, the computer connection device 503 can be an IR transmission device, which has to be used with another IR transmission device in the computer apparatus 90. Then the electronic apparatus 50 can search the records in the third table 603 in the computer storage device 901 of the computer apparatus 90. In the current embodiment, the computer apparatus 90 further connects to the Internet. Thus, the table search module 11 connects to the computer apparatus 90 through the computer connection device 503 and searches for the records stored in the second table 602 via the network.

As described before, the first table 601, the second table 602 and the third table 603 store the correspondence relation between an application 40 and at least one extension. In other words, from the extension of a file 30, the information about the appropriate application 40 for opening the file 30 can be obtained from one of the first table 601, the second table 602, and the third table 603. For example, when the extension of the file 30 is “doc”, the system can find out that the appropriate application 40 for opening such files could be “winword.exe” from the first table 601, the second table 602, or the third table 603.

The table search module 11 automatically searches the first table 601, the second table 602, and the third table 603 in the storage device 501, the network connection device 502 and the computer connection device 503, respectively. The file opening module 12 automatically executes the application 40 from the corresponding relationship between an application 40 and an extension. The application 40 then opens the file 30.

In addition, the auto file opening system 1 further contains an application searching module 13 and an application installation module 14. According to the embodiment, the application searching module 13 automatically obtains the appropriate application 40 from either the web database 801 or the computer storage device 901 when the electronic apparatus 50 is not installed with the application 40. The application installation module 14 installs the obtained application 40 in the electronic apparatus 50 so as to open the file 30.

The table search module 11, the file opening module 12, the application searching module 13, and the application installation module 14 are software modules stored in memory and build their relations through parameters, variables, or events. It should be emphasized that people skilled in the art can use any programming language to implement the functions.

To make the content of the invention more comprehensible, an example is given below to explain the procedure of the auto file opening method 2 according to the preferred embodiment of the invention.

In accordance with a preferred embodiment of the invention, the method 2 is implemented on an electronic apparatus 50 and includes a table searching procedure 21 and a file opening procedure 22. The table searching procedure 21 automatically searches a first table 601, a second table 602 and a third table 603 from a storage device 501, a network connection device 502 and a computer connection device 503, respectively. The file opening procedure 22 follows the corresponding relationship between an application 40 and an extension to automatically execute the application 40. The application 40 then opens the file 30.

Furthermore, the method 2 also contains an application searching procedure 23 and an application installation procedure 24. The application searching procedure 23 automatically obtains the appropriate application 40 from either a web database 801 or a computer storage device 901 when the electronic apparatus 50 is not installed with the application 40. The application installation procedure 24 installs the obtained application 40 in the electronic apparatus 50.

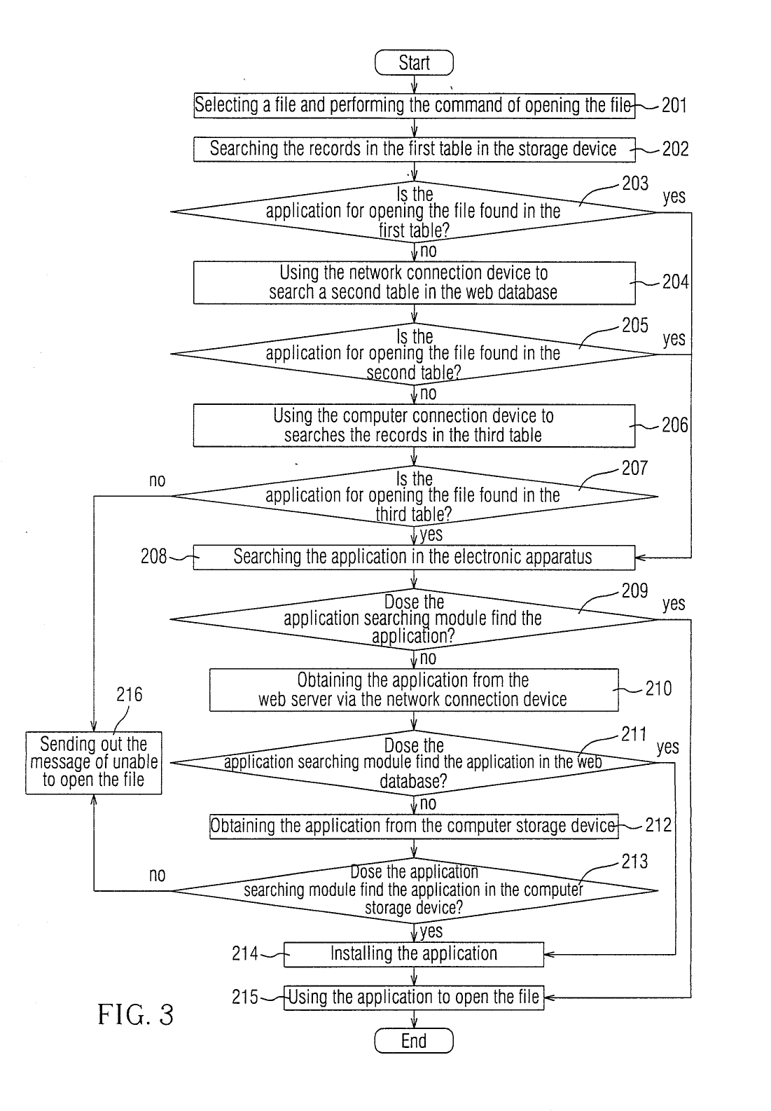

As shown in FIG. 3, a user selects a file 30 and performs the command of opening the file 30 in step 201. In step 202, the method 2 searches the records in the first table 601 in the storage device 501. For example, the user uses a mouse to click on and open a file 30. Thereafter, a table search module 11 obtains a first table 601 from the hard disk drive of the electronic apparatus 50 and searches the records in the first table 601 so as to obtain the corresponding relationship between the extension of the file 30 and the application 40 for opening the file 30.

In step 203, the method 2 determines whether the application 40 for opening the file 30 is found in the first table 601. When the application 40 is not found, step 204 is performed. When the application 40 is found, the method 2 continues to step 208.

In step 204, the method 2 uses the network connection device 502 to search a second table 602 in the web database 801. For example, the table search module 11 sends out a request to the Internet 70 via a modem in order to search the records in the second table 602 in the web database 801 of the web server 80. The data of the application 40 for opening the file 30 can thus be obtained.

In step 205, the method 2 determines whether the application 40 for opening the file 30 is found in the second table 602. When the application 40 is not found, step 206 is performed. When the application 40 is found, the method continues to step 208.

In step 206, the method 2 uses the computer connection device 503 to searches the records in the third table 603 in the computer storage device 901 of the computer apparatus 90. For example, the table search module 11 sends out a request to the computer apparatus 90 via a USB so as to search the records stored in the third table 603 in the computer storage device 901.

Step 207 determines whether the application 40 for opening the file 30 is found in the third table 603. When the application 40 is not found, step 216 is performed to send out the message of unable to open the file 30. When the application 40 is found, the method 2 continues to step 208.

In step 208, an application search module 13 is performed to search the application 40 in the electronic apparatus 50. For example, the application search module 13 finds the application 40 in the memory of the electronic apparatus 50.

In step 209, the method 2 determines whether the application search module 13 finds the application 40 in the electronic apparatus 50. When the application 40 is found in the electronic apparatus 50, step 215 is performed. If the application 40 is not found, step 210 is performed.

In step 210, the application search module 13 obtains the application 40 from the web server 80 via the network connection device 502. For example, the application search module 13 sends out a request to the Internet 70 via a modem so as to obtain the application 40 from the web database 801 in a web server 80.

In step 211, the method 2 determines whether the application search module 13 finds the application 40 in the web database 801. When the application 40 is found in the web server 80, step 215 is performed. If the application 40 is not found, step 212 is performed.

In step 212, the application search module 13 obtains the application 40 from the computer storage device 901 of the computer apparatus 90. For example, the application search module 13 sends out a request to the computer apparatus 90 via a USB so as to obtain the application 40 from the computer storage device 901.

In step 213, the method 2 determines whether the application search module 13 finds the application 40 in the computer storage device 901. When the application 40 is found in the computer storage device 901, step 215 is performed. If the application 40 is not found, step 216 is performed to send out the message of unable to open the file 30.

In step 214, the application installation procedure 24 calls an application installation module 14 to install the application 40.

In step 215, the file opening procedure 22 uses a file opening module 12 to call the application 40 to open the file 30.

Through the aforementioned procedure, the table search module 11 can automatically search the first table 601, the second table 602, and the third table 603 from the storage device 501 of the electronic apparatus 50, the web database 801 of the web server 80 and the computer storage device 901 of the computer apparatus 90, respectively, so as to obtain the information about the application for opening the file 30. It further completes the installation of the application 40 when the application 40 is not installed in the electronic apparatus 50, and automatically runs the application 40 to open the file 30. This method can thus achieve the function and convenience of automatically opening a file 30.

It should be mentioned that step 204 and step 206 do not have a definite order. That is, one can first search the third table 603 in the computer storage device 901, then the second table 602 in the web database 801. These two searches can be combined as an external table searching procedure and any other means can be employed to search for an appropriate extension/application table externally. Analogously, step 210 and step 212 do not have a definite order, either. Thus, one can first search the application 40 in the computer storage device 901 then the web database 801.

Moreover, when there is a plurality of applications that can open the file, the auto file opening system can ask the user to select one application from them to open the file. For example, if in step 202 the table search module 11 finds three applications 40 that can open the file 30 from the first table 601, the auto file opening system generates a dialog window for the user to select an application. Analogously, in step 204 and step 206, if the table search module 11 finds several applications 40 to open the file 30 in the second table 602 or the third table 603, the auto file opening system also asks the user to select an application.

After the user selects an application, the file opening module 12 immediately uses the application selected by the user to open the file. If the application has to be obtained from the web server 80 or the computer apparatus 90, the application search module 13 will then follow the user's selection to obtain the application.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An auto file opening system implemented in an electronic apparatus including a storage device for storing a first table and a network connection device, the electronic apparatus using the network connection device to connect to a web server through the Internet, the web server storing a second table, and the first table and the second table storing the corresponding relationship between an application and at least one extension, wherein the auto file opening system comprises:
a table search module, which automatically searches the corresponding relationship between the application and the extension from the data stored in the first table and the second table; and
a file opening module, which runs the application according to the corresponding relationship between the application and the extension to open a file with the extension.

2. The system of claim 1, wherein the file opening module provides a user choices for selecting one application to open the file when the extension corresponds to a plurality of applications.

3. The system of claim 1 further comprising:
an application searching module, which obtains the application from the web server when the electronic apparatus is not installed with the application; and
an application installation module, which installs the application in the electronic apparatus.

4. The system of claim 3, wherein the file opening module follows the choice of a user to obtain an application from the web server to open the file when the extension corresponds to a plurality of applications.

5. The system of claim 3, wherein the table search module first searches the first table and then searches the second table by connecting to the web server through the network connection device and the Internet when the corresponding relationship between an extension and an application is not found in the first table.

6. The system of claim 1 further comprising a computer connection device, wherein the electronic apparatus uses the computer connection device to connect to a computer apparatus that stores a third table, the third table stores the correspondence relation between the application and the extension, and the table search module automatically searches for the corresponding relationship between the application and the extension in the third table.

7. The system of claim 6, wherein the table search module first searches the first table and then automatically searches the third table by establishing connection with the computer apparatus using the computer connection device when the corresponding relationship between the application and the extension is not found in the first table.

8. The system of claim 6 further comprising:
an application searching module, which obtains the application from the web server when the electronic apparatus is not installed with the application; and
an application installation module, which installs the application in the electronic apparatus.

9. The system of claim 8, wherein the file opening module follows the choice of the user to obtain an application from one of the web server and the computer apparatus to open the file when the extension corresponds to a plurality of applications.

10. The system of claim 1, wherein the network connection device includes a wireless network connection device.

11. An auto file opening method implemented in an electronic apparatus including a storage device for storing a first table and a network connection device, the electronic apparatus using the network connection device to connect to a web server through the Internet, the web server storing a second table, and the first table and the second table storing the corresponding relationship between an application and at least one extension, wherein the auto file opening method comprises:
a table searching procedure, which automatically searches the corresponding relationship between the application and the extension from the data stored in the first table and the second table; and
a file opening procedure, which runs the application according to the corresponding relationship between the application and the extension to open a file with the extension.

12. The method of claim 11, wherein the file opening procedure provides a user choices for selecting one application to open the file when the extension corresponds to a plurality of applications.

13. The method of claim 11 further comprising:
an application searching procedure, which obtains the application from the web server when the electronic apparatus is not installed with the application; and
an application installation procedure, which installs the application in the electronic apparatus.

14. The method of claim 13, wherein the file opening procedure follows the choice of a user to obtain an application from the web server to open the file when the extension corresponds to a plurality of applications.

15. The method of claim 13, wherein the table search procedure first searches the first table and then searches the second table by connecting to the web server through the network connection device and the Internet when the corresponding relationship between the application and the extension is not found in the first table.

16. The method of claim 11 further comprising a computer connection procedure, wherein the electronic apparatus uses a computer connection device to connect to a computer apparatus that stores a third table, the third table stores the corresponding relationship between the application and the extension, and the table search procedure automatically searches for the corresponding relationship between the application and the extension in the third table.

17. The method of claim 16, wherein the table search procedure first searches the first table and then automatically searches the third table by establishing connection with the computer apparatus using a computer connection device when the corresponding relationship between an extension and an application is not found in the first table.

18. The method of claim 16 further comprising:
an application searching procedure, which obtains the application from the web server when the electronic apparatus is not installed with the application; and
an application installation procedure, which installs the application in the electronic apparatus.

19. The method of claim 18, wherein the file opening procedure follows the choice of a user to obtain an application from one of the web server and the computer apparatus to open the file when the extension corresponds to a plurality of applications.

20. The method of claim 11, wherein the network connection device includes a wireless network connection device.
